(19) United States
(12) Patent Application Publication
(10) Pub. No.: US 2026/0067775 A1
(43) Pub. Date: Mar. 5, 2026

(54) METHODS, ARCHITECTURES, APPARATUSES AND SYSTEMS FOR CELL HANDOVER

(71) Applicant: InterDigital Patent Holdings, Inc., Wilmington, DE (US)

(72) Inventors: Brian Martin, Farnham (GB); Oumer Teyeb, Montreal (CA); Martino Freda, Laval (CA); Paul Marinier, Brossard (CA); Keiichi Kubota, Setagaya-Ku (JP)

(21) Appl. No.: 19/116,840

(22) PCT Filed: Sep. 28, 2023
(86) PCT No.: PCT/US2023/033988

§ 371 Date: Mar. 28, 2025

Related U.S. Application Data
(60) Provisional application No. 63/410,777, filed on Sep. 28, 2022.
(60) Provisional application No. 63/420,306, filed on Oct. 28, 2022.
(60) Provisional application No. 63/456,262, filed on Mar. 31, 2023.

(51) Int. Cl. H04W 36/08; H04W 36/00

(52) U.S. Cl. CPC H04W 36/08; H04W 36/0016; H04W 36/0061

(57) ABSTRACT

Procedures, methods, architectures, apparatuses, systems, devices, and computer program products for cell handover of a wireless transmit-receive unit, WTRU, and radio resource control, RRC, configuration overhead and/or data retransmission are reduced. An RRC reconfiguration data structure is rendered modular by splitting the data structure into configuration parts, e.g., CU, DU and cell-specific parts. One configuration can be provided per CU, one configuration per DU, and one configuration per cell. According to an embodiment, one candidate cell group configuration is provided for each potential SCG and for each potential MCG. Any part of the configuration may be provided with an ID. By using common building blocks and IDs, the WTRU may determine, based on the IDs of the source and target cell configurations, what the delta configuration is, and apply any necessary configurations and associated actions.

### CROSS-REFERENCE TO RELATED APPLICATIONS

This application claims the benefit of U.S. Provisional Patent Application Nos. (i) 63/410,777 filed 28 Sep. 2022, (ii) U.S. Provisional Patent Application No. 63/420,306 filed 28 Oct. 2022, and (iii) U.S. Provisional Patent Application No. 63/456,262 filed 31 Mar. 2023; each of which is incorporated herein by reference.

### FIELD

The present disclosure is generally directed to the fields of communications, software and encoding, including, for example, to methods, architectures, apparatuses, systems related to handover of a wireless transmit-receive unit from a source cell to a target cell.

### BACKGROUND

With a conventional L3 handover or conditional a wireless transmit-receive unit (WTRU) will typically first send a measurement report using Radio Resource Control (RRC) signalling. In response to this the network may provide a further measurement configuration and potentially a conditional handover (CHO) configuration. With a conventional handover the network provides a configuration for a target cell after the WTRU reports using RRC signalling that the cell meets a configured radio quality criteria. With conditional handover, to reduce the handover failure rate due to the delay in sending a measurement report then receiving an RRC reconfiguration the network provides, in advance, a target cell configuration as well as a measurement criteria which determines when the WTRU should trigger the CHO configuration. Both of these L3 methods, however, do suffer from some amount of delay due to the sending of measurement reports and receiving of target configurations, particularly in case of the conventional (non-conditional) handover. There is a need to reduce handover latency.

### SUMMARY

According to one aspect of the present disclosure, there are provided methods, implemented by a WTRU, according to the described embodiments and appended claims.

According to a further aspect of the present disclosure, embodiments of WTRU, are described and are claimed in the appended claims.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a sequence diagram depicting a basic handover procedure in New Radio (NR);

FIG. 3 is an abstract syntax notation one (ASN.1) representation of an excerpt of a Radio Resource Control (RRC) reconfiguration message;

FIGS. 4A-4D depict an ASN.1 representation of other related information elements (IEs) of the RRC reconfiguration message of FIG. 3;

FIG. 5 is an illustration of cell groups and cells;

FIG. 6 is an example physical layer (L1)/radio link control (L2) inter-cell mobility using carrier aggregation (CA);

FIG. 7 is a flow chart of an embodiment of a method for handover using modular RRC configuration for pre-configured cells, that minimises RRC configuration overhead and also ensure that there is no unnecessary data retransmission or data loss, while correctly enabling multiple primary cell changes;

FIG. 8 summarizes existing RRC reconfiguration ASN.1 structure;

FIG. 9 is an embodiment of a rearranged, modular, RRC reconfiguration ASN. 1 structure;

FIG. 10 is an embodiment of an alternative coding of modular parts and relations;

FIG. 11 is an embodiment of a further alternative coding of modular parts and relations;

FIG. 12 is related to steps 704 and 705a-b of FIG. 7 while referring to the further alternative embodiment of FIG. 11;

FIG. 13 is a flow chart of a method for cell handover according to an embodiment;

FIG. 14 is a flow chart of a method for cell handover according to a further embodiment; and

FIG. 15 is a flow chart of a method, implemented by a WTRU, for cell handover according to a further embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

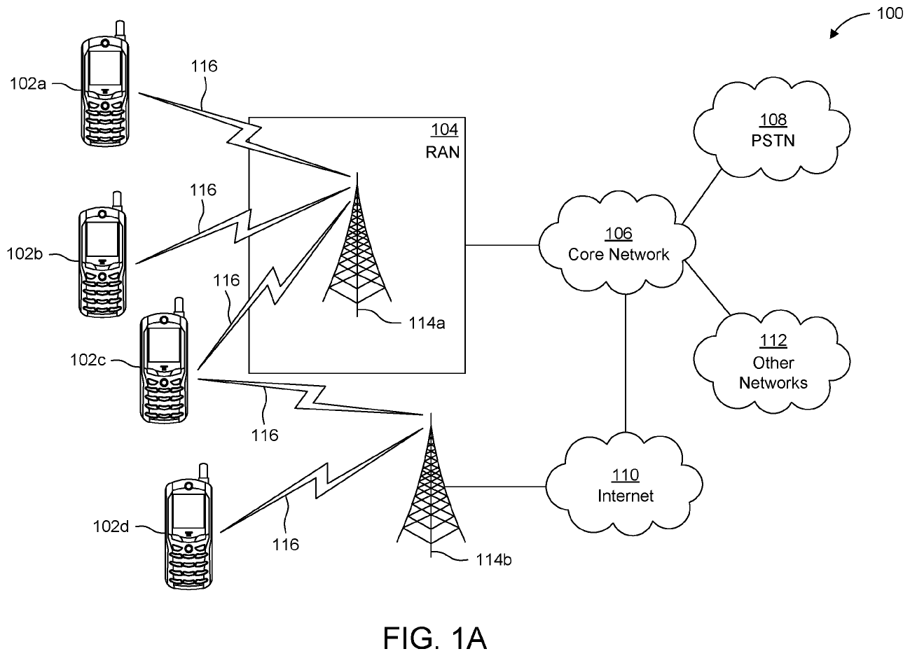

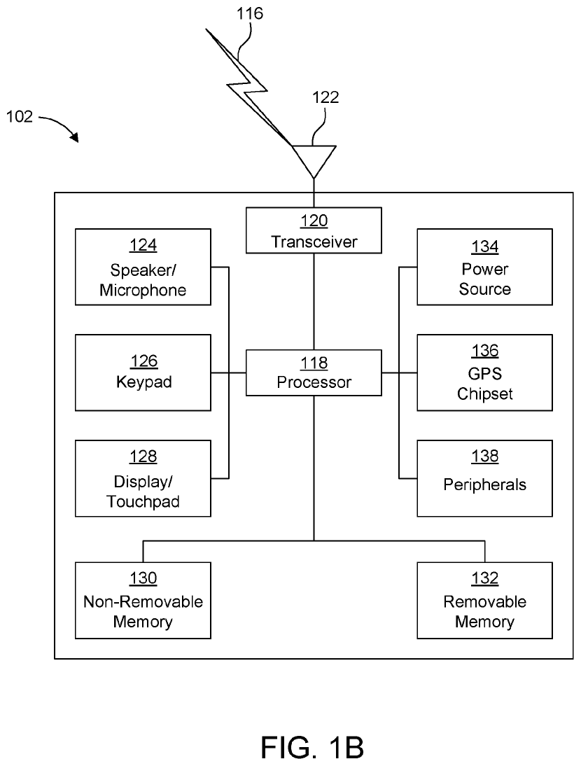

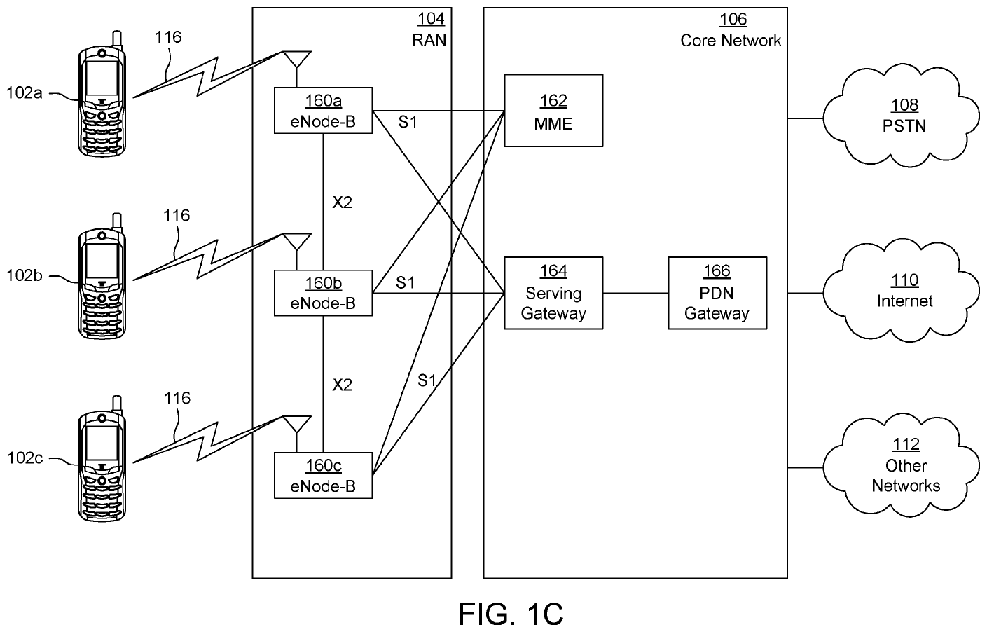

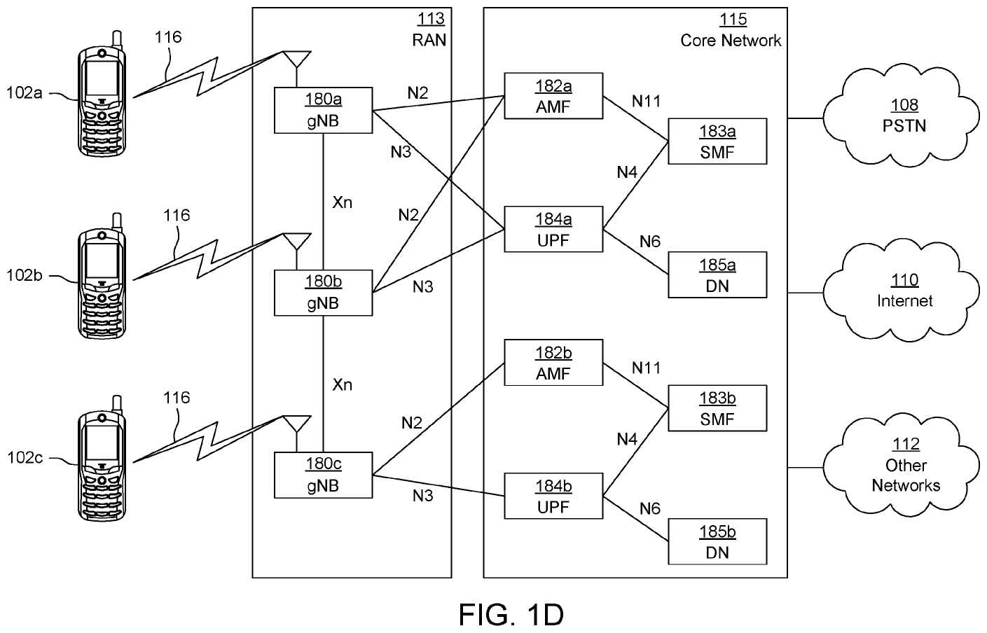

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following is a list of abbreviations used herein:
ACK Acknowledgement
AS Application Server
BLER Block Error Rate
BWP Bandwidth Part
CA Carrier aggregation
CC Component Carrier
CCE Control Channel Element
CHO Conditional handover
CE Control Element
CG Configured grant or cell group
CP Cyclic Prefix
CPA Conditional PSCell Addition
CPC Conditional PSCell Change
CQI Channel Quality Indicator
C-RNTI Cell Radio-Network Temporary Identifier
CSI Channel State Information
CSI-RS CSI Reference Signals
CU Centralized Unit
DC Dual connectivity
DCI Downlink Control Information
DG Dynamic grant
DL Downlink
DM-RS Demodulation Reference Signal
DRB Data Radio Bearer
DRX Discontinuous reception
DU Distributed Unit
FR1/2 Frequency Range 1/2
HARQ Hybrid Automatic Repeat Request
HO HandOver
ID Identifier
L1 5G NR Physical Layer
L2 5G NR MAC, RLC and PDCP layer
L3 5G NR RRC layer
LTE Long Term Evolution e.g., from 3GPP LTE R8 and up
NACK Negative ACK
MAC Medium access control
MAC CE MAC Control Element
MCG Master cell group
MCS Modulation and Coding Scheme
MIMO Multiple Input Multiple Output
NR New Radio
OFDM Orthogonal Frequency-Division Multiplexing
PCell Primary cell
PDCP Packet Data Convergence Protocol
PDCCH Physical Downlink Control Channel
PDSCH Physical Downlink Shared Channel
PHY Physical Layer (L1)
PO Paging Occasion
PRACH Physical Random Access Channel
PSCell Primary SCG Cell
PSS Primary Synchronization Signal
RA Random Access (or procedure)
RACH Random Access Channel
RAR Random Access Response
RLC Radio Link Control
RLC-AM RLC Acknowledged Mode
RLF Radio Link Failure
RLM Radio Link Monitoring
RNTI Radio Network Identifier
RO RACH occasion
RRC Radio Resource Control
RRM Radio Resource Management
RS Reference Signal
RSRP Reference Signal Received Power
RSSI Received Signal Strength Indicator
SCell Secondary cell
SCG Secondary cell group
SCH Shared channel
SDAP Service Data Adaptation Protocol
SDU Service Data Unit
SMTC SSB-based Measurement Timing Configuration
SpCell Special Cell*
SRS Sounding Reference Signal
SS Synchronization Signal
SSS Secondary Synchronization Signal
SWG Switching Gap (in a self-contained subframe)
SPS Semi-persistent scheduling
SUL Supplemental Uplink
TA Timing advance
TAG Timing advance group
TB Transport Block
TBS Transport Block Size
TCI Transmission Configuration Indication
TRP Transmission/Reception Point
TSC Time-sensitive communications
TSN Time-sensitive networking
UL Uplink
   * The term SpCell either refers to the PCell of the MCG or the PSCell of the SCG depending on whether the MAC entity is associated to the MCG or the SCG.

### Handover—Procedure overview

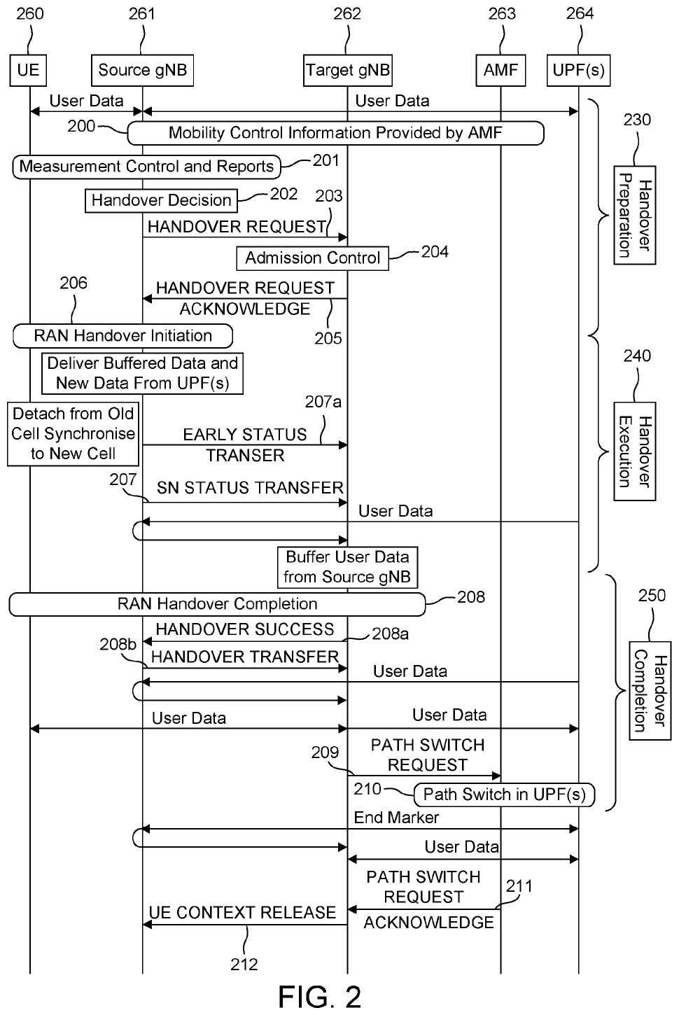

FIG. 2 depicts a basic handover procedure in NR. The entities shown are, from top left to top right, WTRU 260, Source gNB 261, Target gNB 262, AMF 263, and UPF 261. From top right to bottom right, are shown the different phases of the handover, with a handover preparation phase 230, a handover execution phase 240, and a handover completion phase 250.

In 200, the WTRU context within the source gNB contains information regarding roaming and access restrictions which were provided either at connection establishment or at the last TA (Timing Advance) update.

In 201, the source gNB configures the WTRU measurement procedures and the WTRU reports according to the measurement configuration.

In 202, the source gNB decides to handover the WTRU, based on the received measurements.

In 203, the source gNB issues a Handover Request message to the target gNB passing a transparent RRC container with necessary information to prepare the handover at the target side. The information includes at least the target cell ID, KgNB* (KgNB* is an intermediate security key, derived when performing a horizontal or vertical key derivation), the C-RNTI of the WTRU in the source gNB, RRM-configuration including WTRU inactive time, basic AS-configuration including antenna Info and DL Carrier Frequency, the current QoS flow to DRB mapping rules applied to the WTRU, the system information block 1 (SIB1) from source gNB, the WTRU capabilities for different RATs, PDU session related information, and can include the WTRU reported measurement information including beam-related information if available.

In 204, admission control may be performed by the target gNB.

In 205, if the WTRU can be admitted, the target gNB prepares the handover with L1/L2 and sends the HANDOVER REQUEST ACKNOWLEDGE to the source gNB, which includes a transparent container (a container that doe not need to be decoded by the source gNB) to be sent to the WTRU as an RRC message to perform the handover.

In 206, the source gNB triggers the Uu handover by sending an RRCReconfiguration message to the WTRU, containing the information required to access the target cell: at least the target cell ID, the new C-RNTI, the target gNB security algorithm identifiers for the selected security algorithms. It can also include a set of dedicated RACH resources, the association between RACH resources and synchronization signal block (SSB(s)), the association between RACH resources and WTRU-specific CSI-RS configuration(s), common RACH resources, and system information of the target cell, etc.

In 207, the source gNB sends the SN STATUS TRANSFER message (SN stands for sequence number) to the target gNB to convey the uplink PDCP SN receiver status and the downlink PDCP SN transmitter status of DRBs for which PDCP status preservation applies (i.e., for RLC AM).

In 208, the WTRU synchronizes to the target cell and completes the RRC handover procedure by sending RRCReconfigurationComplete message to target gNB.

In 209, the target gNB sends a PATH SWITCH REQUEST message to AMF to trigger 5GC to switch the DL data path towards the target gNB and to establish an NG-C interface instance towards the target gNB.

In 210, 5GC switches the DL data path towards the target gNB. The UPF sends one or more “end marker” packets on the old path to the source gNB per PDU session/tunnel and then can release any U-plane/TNL resources towards the source gNB.

In 211, the AMF confirms the PATH SWITCH REQUEST message with the PATH SWITCH REQUEST ACKNOWLEDGE message.

In 212, upon reception of the PATH SWITCH REQUEST ACKNOWLEDGE message from the AMF, the target gNB sends the UE CONTEXT RELEASE to inform the source gNB about the success of the handover. The source gNB can then release radio and C-plane related resources associated to the WTRU context. Any ongoing data forwarding may continue.

### Handover—Configuration Details

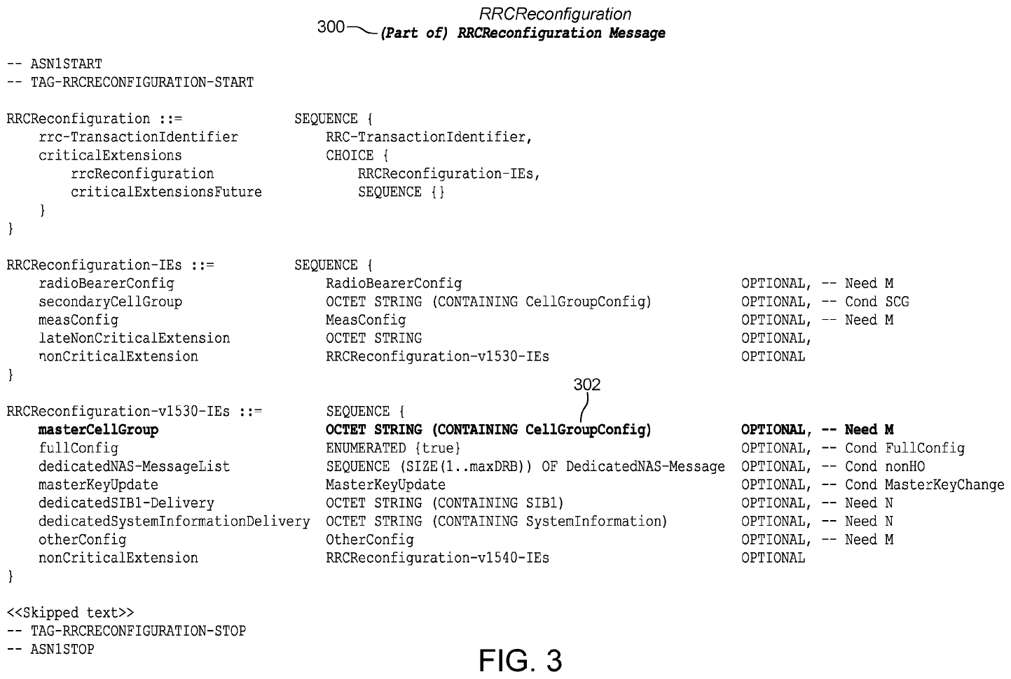

A HO command is basically an RRCReconfiguration message that contains a reconfiguration WithSync. An excerpt of the RRC Reconfiguration message, and other related information elements (IEs) is shown in FIGS. 3A-3C.

The RRCReconfiguration message 300 (see FIG. 3) contains the cell group configuration 302 (the master cell group, and possibly the secondary cell group, if dual connectivity, DC, is configured).

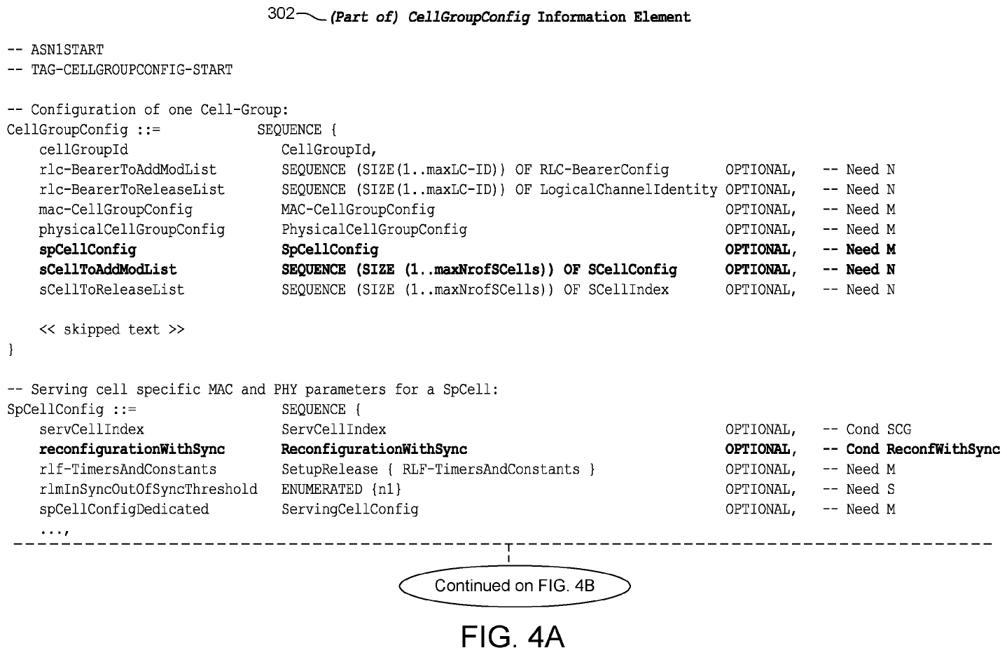

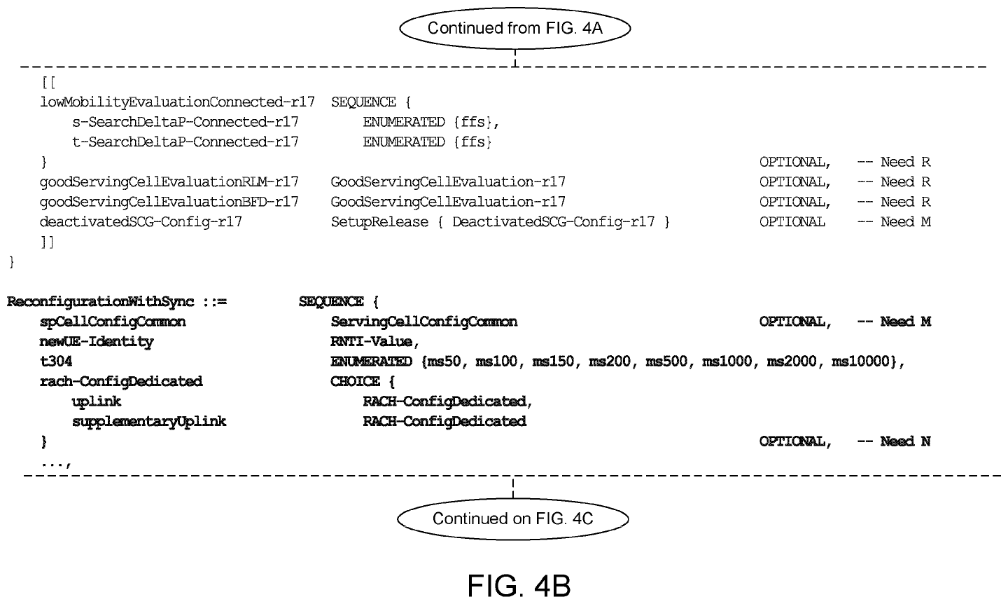

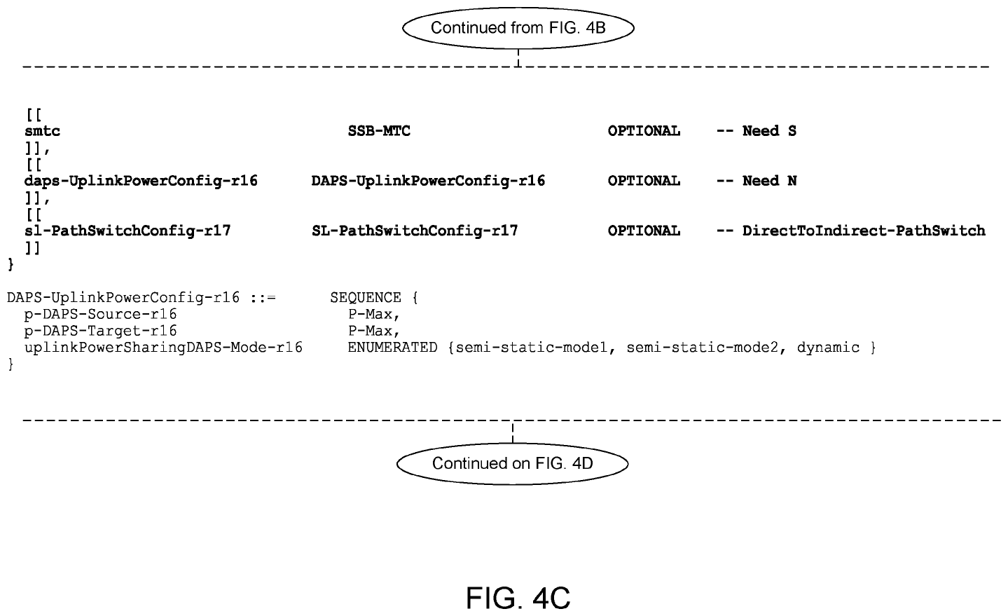

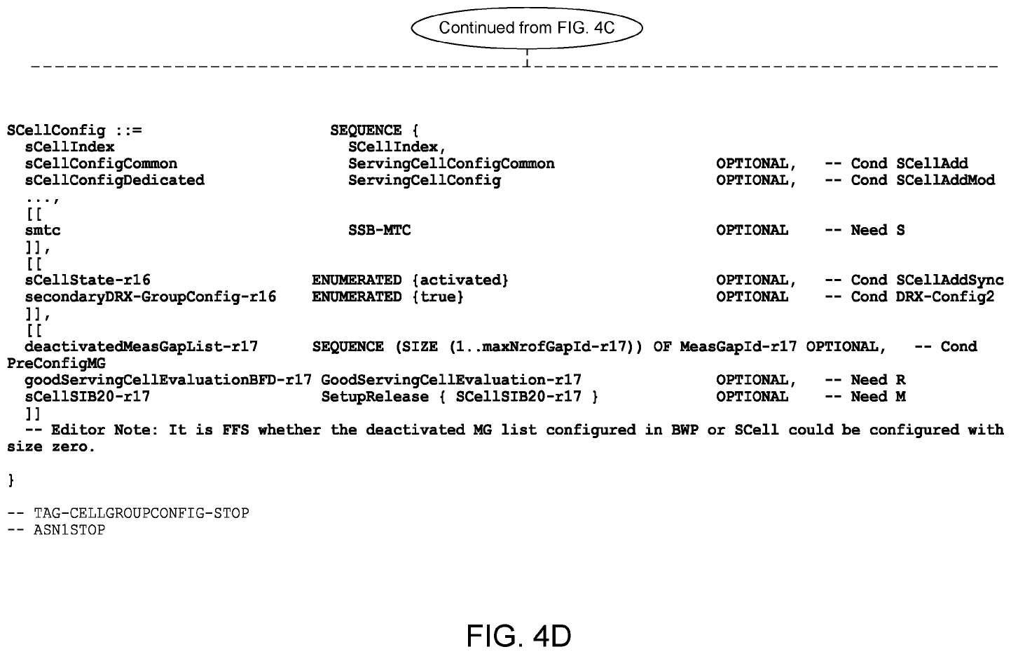

The cell group configuration (element 302 in FIGS. 3 and 4A-4D) contains the configuration of all the cells that belong to the cell group (i.e., those cells that are operating in carrier aggregation, CA). These cells, collectively known as serving cells, are divided into the primary cell and the secondary cells.

The primary cell is the cell operating on the primary frequency, in which the WTRU either performs the initial connection establishment procedure or initiates the connection re-establishment procedure, or the cell indicated as the primary cell in the handover procedure. The primary cell for the master cell group is referred to as the PCell, while (in case DC is configured), the primary cell for the secondary cell group is called the PSCell (Primary Secondary Cell). The term SpCell (special cell) is used to refer to the PCell and PSCell.

A secondary cell (SCell) is a cell that is providing the other carriers that are used during carrier aggregation for the corresponding cell group.

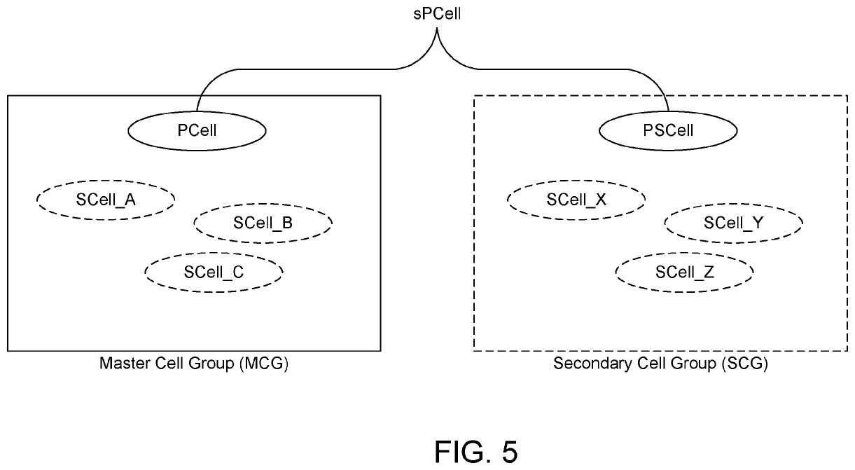

FIG. 5 is an illustration of cell groups and cells. Many operations such as radio link monitoring (RLM) and associated Radio Link Failure (RLF) detection and recovery are relevant to the primary cell only.

Each serving cell is identified by a servCellIndex (serving cell index), that can take a value from 0 to 31. The PCell is always assigned a servCellIndex value of 0.

### Inter-cell L1/2 Mobility

3GPP TSG RAN R17 supports inter-cell L1/2 mobility for managing the beams in CA case, but no cell change/add is supported.

In 3GPP TSG RAN R18, one of the objectives of the Work Item “Further NR Mobility Enhancements” is to specify mechanism and procedures of L1/L2-based inter-cell mobility for mobility latency reduction including:
Configuration and maintenance for multiple candidate cells to allow fast application of configurations for candidate cells [RAN2, RAN3];
Dynamic switch mechanism among candidate serving cells (including SpCell and SCell) for the potential applicable scenarios based on L1/L2 signalling [RAN2, RAN1];
L1 enhancements for inter-cell beam management, including L1 measurement and reporting, and beam indication [RAN1, RAN2];
Note 1: Early RAN2 involvement is necessary, including the possibility of further clarifying the interaction between this bullet with the previous bullet
Timing Advance management [RAN1, RAN2];
CU-DU interface signaling to support L1/L2 mobility, if needed [RAN3];
Note 2: FR2 specific enhancements are not precluded, if any.
Note 3: The procedure of L1/L2 based inter-cell mobility are applicable to the following scenarios:
Standalone, CA and NR-DC case with serving cell change within one CG;
Intra-DU case and intra-CU inter-DU case (applicable for Standalone and CA: no new RAN interfaces are expected);
Both intra-frequency and inter-frequency;
Both FR1 and FR2;
Source and target cells may be synchronized or non-synchronized;
Inter-CU case is not included.

L1/L2 based mobility was originally started in R17 and inter-cell beam management in R17 addresses intra-DU and intra-frequency scenarios. In this case the serving cell remains unchanged (i.e., there is no possibility to change the serving cell using L1/2 based mobility). In FR2 deployments, CA is typically used to exploit the available bandwidth, e.g., to aggregate multiple CCs in one band. These CCs are typically transmitted with the same analog beam pair (gNB beam and WTRU beam). The WTRU is configured with TCI states (can have fairly large number, e.g., 64) for reception of PDCCH and PDSCH. Each TCI state includes a RS or SSB that the WTRU refers to for setting its beam. For R17, the SSB can be associated with a non-serving PCI. MAC signaling (“TCI state indication for WTRU-specific PDCCH MAC CE”) activates the TCI state for a Coreset/PDCCH. Reception of PDCCH from a non-serving cell is supported by MAC CE indicating a TCI state associated to non-serving PCI. MAC signaling (“TCI States Activation/Deactivation for WTRU-specific PDSCH”) activates a subset of (up to) 8 TCI states for PDSCH reception. DCI indicates which of the 8 TCI states. R17 also supports “unified TCI state” with a different updating mechanism (DCI-based), but without multi-TRP. R18 will support unified TCI state with multi-TRP.

The overall objective of L1/2 inter-cell mobility is to improve handover latency; with a conventional L3 handover or conditional the WTRU will typically first send a measurement report using RRC signalling. In response to this the network may provide a further measurement configuration and potentially a conditional handover configuration. With a conventional handover the network provides a configuration for a target cell after the WTRU reports using RRC signalling that the cell meets a configured radio quality criteria. With conditional handover, to reduce the handover failure rate due to the delay in sending a measurement report then receiving an RRC reconfiguration the network provides, in advance, a target cell configuration as well as a measurement criteria which determines when the WTRU should trigger the CHO configuration. Both of these L3 methods, however, do suffer from some amount of delay due to the sending of measurement reports and receiving of target configurations, particularly in case of the conventional (non-conditional) handover.

In particular, the aim of L1/2 based inter-cell mobility is to allow a fast application of configurations for candidate cells, including dynamically switching between SCells and switching of the PCell (e.g., switch the roles between SCell and PCell) without performing RRC signalling. The inter-CU case is not included in the R18 work, as this requires relocation of the PDCP anchor and has already been excluded from the work item. Therefore, improvement is needed, and according to embodiments, an RRC based approach is disclosed at least to support inter-CU handover. One of the aims of L1/2 should also be to allow CA operation to be enabled instantaneously upon serving cell change.

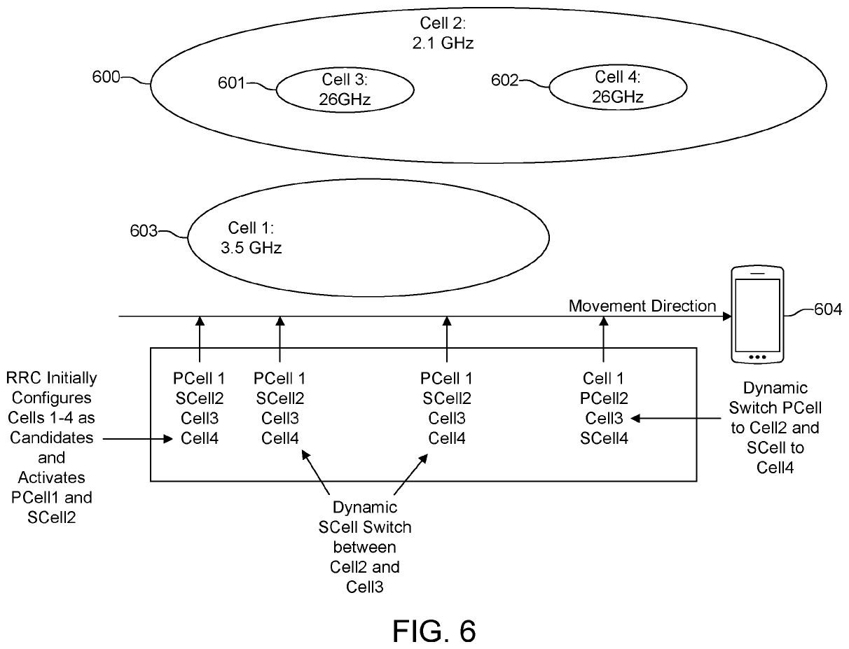

FIG. 6 shows an example of L1/2 inter-cell mobility operation using CA, whereby the candidate cell group is configured by RRC and a dynamic switch of PCell and SCell is achieved using L1/2 signalling. As a WTRU 504 moves through the coverage of multiple cells, e.g., here through the coverage of Cell 1 (603), Cell 2 (600), Cell 3 (601), and Cell 4 (602), at Cell 1, RRC initially configures cells 1-4 as candidates and activates Cell 1 as the PCell (PCell1) and Cell 2 as the SCell (SCell2). Then, as the WTRU has moved to the next position, a dynamic SCell switch is operated between Cell 2 and Cell 3 such that cell 2 is deactivated and cell 3 is activated as SCell. At the next position, a dynamic SCell switch is operated between Cell 2 and Cell 3 such that cell 3 is deactivated and cell 2 is activated once more as SCell. At the next position, a dynamic and simultaneous PCell and SCell switch is operated such that Cell 2, previously an Scell, becomes the new PCell and Cell 4 becomes the new SCell, while Cell 1 is deactivated.

### Reducing RRC Configuration Overhead

For L1/2 mobility, and also CHO/CPC/CPA with multiple “hops”, the RRC configuration overhead is significant, since multiple candidate target cells must be pre-configured before the handover is triggered. This results in signalling overhead (i.e., over the air) and WTRU storage overhead.

This has already been recognized, with 3GPP RAN2 agreeing in the RAN2 WG meeting #119 the following: “RAN2 to consider preparation of target cell configurations capable of dynamic switching without need for full configuration.”

In conventional handover using an RRC reconfiguration message, it is possible for the network to signal a “delta” configuration—that is, in order to reduce overhead, to signal only the difference between the current (source) cell configuration and the new (target) cell configuration. To support delta configuration after multiple “hops” (i.e., cell handover across multiple pre-configured cells) the delta configuration for the target should also depend on the delta configuration of the source. One possibility would be that every target cell is configured with a delta configuration based on the original cell (the cell providing the pre-configuration). For example, the WTRU may be configured with baseline_config when the PCell is cell1, and configA for candidate cellA, which is a delta configuration from baseline_config, and configB for cellB, which is also a delta configuration from baseline_config. When the PCell changes to cellA, the WTRU applies configA. However, if the WTRU then have to change the PCell to cellB, configB cannot be directly applied. Thus, the WTRU has to revert to the baseline_configuration (i.e., a full configuration) followed by the delta configuration configB.

When a WTRU does a full configuration, it releases all current dedicated radio configuration except for the MCG C-RNTI, AS security configuration and radio bearer (signalling and data), and logged measurements (TS 38.331, section 5.3.3.11). This has several undesirable implications like the loss of any buffered data (waiting first transmission or re-transmission) at RLC/MAC level, which will cause data transmission interruption and may also lead to data loss (e.g., if the discard timer has expired for a packet at PDCP level). That is one of the reasons that full configuration is rarely used (in addition to having a disadvantage of creating signalling overhead), mostly only on RRC re-establishments where the WTRU has to restart the connection from scratch after a failure such as a Radio Link Failure (RLF) or during connection resumption from INACTIVE state in the scenario where the target node/cell where the WTRU is resuming the connection has some incompatibility with the source node/cell where the WTRU was sent to the INACTIVE state.

In addition, the following has been agreed in RAN2 WG meeting #119 “R2 assumes that L2 is continued whenever possible (e.g., intra-DU), without Reset, with the target to avoid data loss, and the additional delay of data recovery.” What this means is, at least for the intra-DU case, the RLC/PDCP and MAC reset may not be necessary. For the intra-DU case, there is no reason to reset the MAC (as is done with conventional L3 handover in order to cover all cases) if the MAC configuration is identical for both cells since the MAC resides in the DU part of the network. The RLC and PDCP reside in the CU, therefore for L1/2 mobility, it may be possible to keep RLC and PDCP unchanged and avoid re-establishing them. For other cases, such as CHO, the handover may be across CUs and therefore RLC/PDCP may need to be re-established.

An objective of the proposed method according to embodiments, is to minimize RRC configuration overhead and also ensure that there is no unnecessary data retransmission or data loss, while correctly enabling multiple primary cell changes.

### Handover Using Modular RRC Configuration

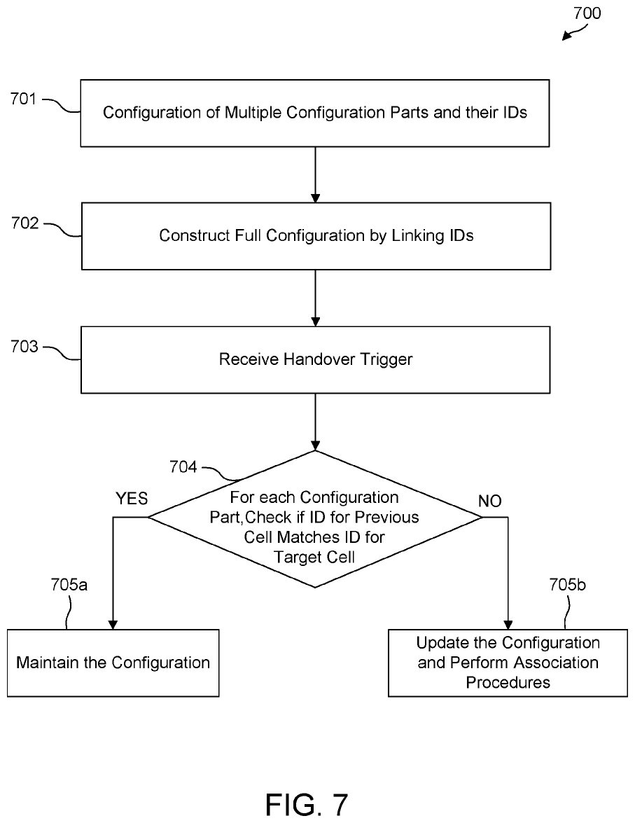

FIG. 7 is a method 700 for handover using modular RRC configuration for pre-configured cells according to an embodiment.

In 701, the WTRU may receive a configuration to be used for multiple cells consisting of multiple configuration parts and an ID for each configuration part.

In 702, the WTRU may also receive an indication (e.g., as part of the configuration) how to construct the full configuration for each of the cells, which refers to the corresponding ID of each part to use in the cell configuration.

In 703, the WTRU may receive a handover trigger (e.g., L1/2 mobility command).

In 704, for each configuration part the WTRU may compare the ID of the source cell and the target cell, for those configuration parts that are different the WTRU may, in step 705b, apply the change and any relevant procedures associated with that change, and for parts which are not different the WTRU may, in step 705a, keep the existing configuration and may not perform the associated procedures.

### Handover Using Modular RRC Configuration: RRC Reconfiguration Structure

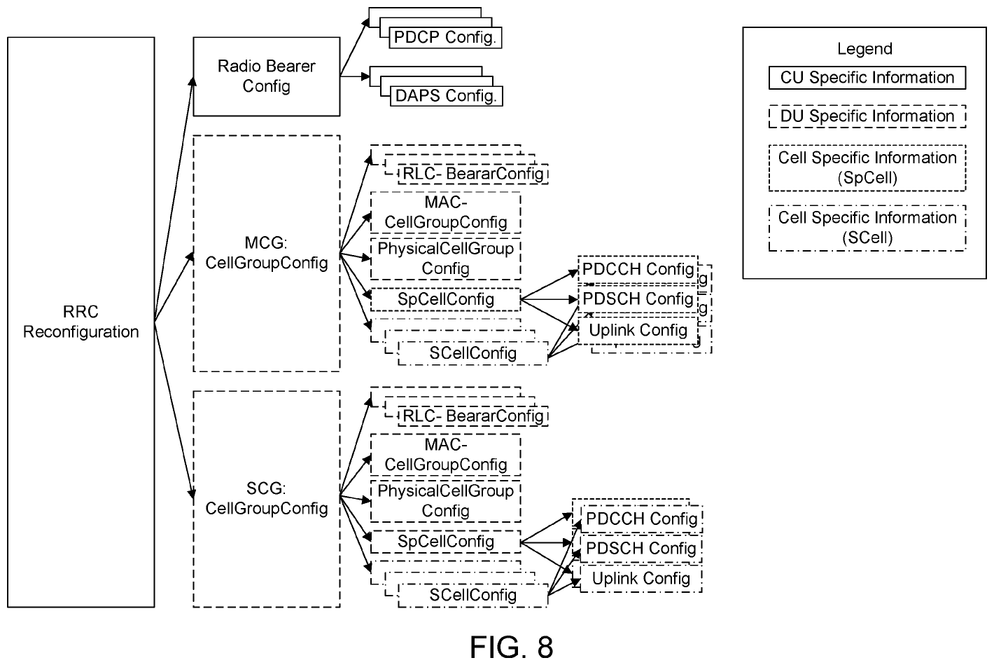

FIG. 8 summarizes an existing RRC Reconfiguration ASN.1 structure. Not every part of the configuration is shown, but some of the parts of the configuration have been chosen, that help to illustrate the concept. As can be seen, the different parts of the hierarchical structure of a radio bearer reconfiguration may be summarized as being:

CU specific information (shown as solid-line rectangles), typically residing in the top level of the RRC reconfiguration message (e.g., the radio bearer configuration containing PDCP and SDAP configuration, which would reside in the CU in an NR CU/DU split architecture). Other information elements at this level (not shown in the figure) include measurement configuration, security configuration, other config (which is related to other aspects like delay budget reporting, overheating assistance information reporting, etc).

DU specific information (shown as short-dashed rectangles), typically residing within the cell group configuration part of the message. The RRC reconfiguration message may contain a Cell group configuration for the MCG only (in case of standalone NR without DC), the SCG only (in case of EN-DC) or both MCG and SCG (in case of NR-DC). The cell group specific information contains RLC bearer configuration, MAC cell group configuration, and physical cell group configuration. These parts typically reside in the DU part of the network in case of CU/DU split architecture.

Cell specific information (shown as long-dashed rectangles for SpCell and as long-dashed-dot rectangles for SCell). Typically, this is physical layer related information which may differ per individual cell.

### Handover Using Modular RRC Configuration: Modular RRC Configuration

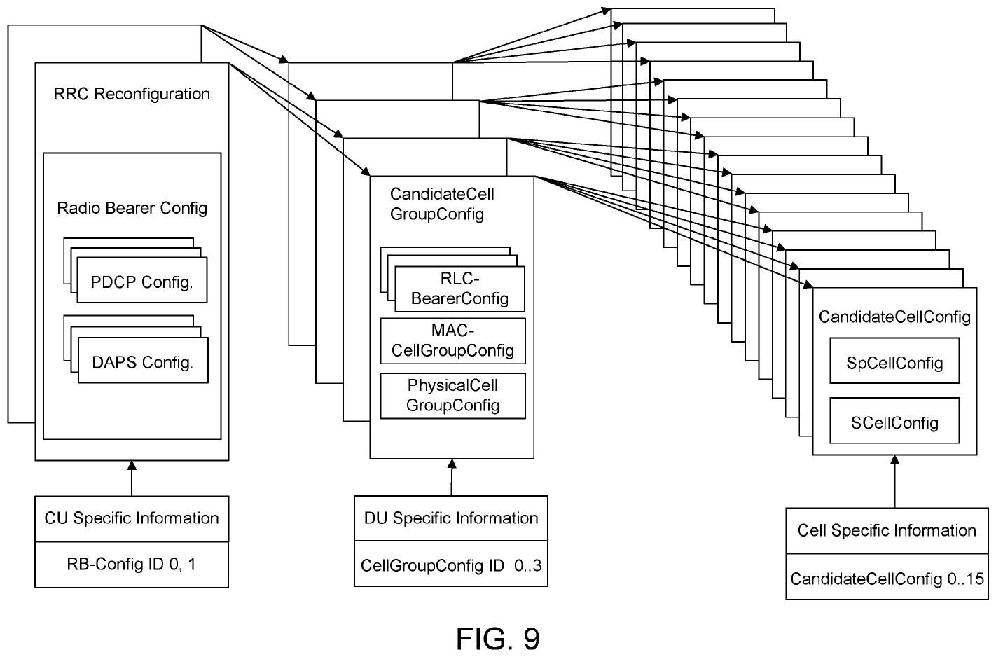

According to embodiments, by taking advantage of the network architecture, with different parts of the configuration relating to different parts of the network, the network may use common configuration for certain parts of the cell configuration. For example, according to an embodiment, if two candidate cells belong to the same DU then the MAC configuration may be identical, or almost identical, the configuration itself may be shared, and then there would be no need to perform a MAC reset when reconfiguring between the two cells. In order to support this, the ASN.1 structure may be rearranged as per one example embodiment shown in FIG. 9.

As can be seen in this figure, the RRC configuration may be split into parts, e.g., CU, DU, and cell-specific parts. Then one configuration may be provided per CU, one configuration may be provided per DU, and one configuration may be provided per cell. In an alternative embodiment, one RRC reconfiguration may be provided for SCG and another for MCG. In yet another alternative embodiment, one candidate cell group configuration may be provided for potential SCG and for potential MCG, for example, for each potential SCG and for each potential MCG.

In addition, and according to an embodiment, an ID may be provided or derived for each CU, DU, and cell configuration (e.g., radio bearer config ID, candidate cell group configuration ID, and candidate cell configuration ID). Each candidate cell (with candidate cell ID) may be provided with both an SpCell and an SCell configuration, or alternatively SpCell configurations and Scell configurations may be provided with separate IDs (e.g., treated as separate cell configurations). Even for different CUs, DUs, cells, some of the configuration might be the same. For example, the network might provide an identical uplink configuration in every cell. In this case the Uplink configuration may be assigned an ID, and each cell configuration may refer to that uplink configuration ID. Similarly, any part of the configuration may be provided with an ID, so that any common configurations may be provided once with an ID, and this may be referred to on the overall configuration. In general, the configuration may be split into many smaller blocks, each provided with an ID that may be referred to when constructing an overall configuration. By doing this, the configuration overhead may be minimised by taking advantage of common parts even when configuring many cells belonging to several DUs or CUs.

A second advantage is that, by using this type of structure with common building blocks and IDs, the WTRU may determine based on the IDs of the source and target cell configurations what the “delta” configuration is, without having to refer to the original cell on which the configuration was received, or a “baseline” configuration. The WTRU may calculate the “delta” directly based on the current (Source) cell configuration and the target cell configuration. Additionally, the WTRU may determine which procedures it has to execute-for example, if the radio bearer configuration ID of the source and target is the same, then PDCP (and maybe even the RLC) may not need to be re-established, while if the IDs are different then the WTRU may need to perform RLC and PDCP re-establishment. By assigning this behaviour to the radio bearer configuration, this also avoids the network needing to expose its actual architecture any more than the conventional RRC reconfiguration (i.e., WTRU just follows the radio bearer configuration and a CU ID is not explicitly indicated). Similarly, if the cell group configuration ID of the source and target is identical, then MAC may not need to be reset and the configuration may not need to change, while if the source and target cell group configuration IDs are different then the WTRU may perform MAC reset. A similar check can be done on any configuration part ID to determine whether to update the configuration and which procedures (actions) to execute (to perform). For example, the WTRU may determine based on comparing an ID provided for each cell whether or not cells are synchronised (same ID) or not (different ID) or may determine whether or not cells are on the same physical site and therefore may use the same timing advance or not. This may for example be used to determine whether to use a RACH procedure (e.g., if the TA needs to be obtained using a RACH procedure), or a RACH-less procedure (e.g., if TA can be assumed to be the same in source and target cells) when reconfiguring from one cell to another.

Example procedures to execute when performing a cell change may include, but are not limited to:
MAC reset;
PDCP re-establishment;
RLC re-establishment;
Security refresh;
Physical layer synchronisation;
Random access;
System information acquisition;
Measurement configuration or conditional reconfiguration update;
Neighbour cell relation update;
Tracking area update/registration;
C-RNTI change;
SCG activation/deactivation;
SCell activation/deactivation;
RACH procedure (sending PRACH and receiving TA in RAR);
RACH-less procedure (if TA is known in advance).

According to an embodiment, the handover trigger (e.g., the L1/2 mobility command or CHO trigger) may refer only to the candidate cell ID. From this candidate cell ID, and the preconfigured associations to other parts of the configuration, the WTRU may determine the cell group configuration ID and the Radio bearer configuration ID. According to other embodiments, the handover trigger may explicitly specify the cell group ID, the cell group type (e.g., MCG, SCG), and the SpCell and the SCells to include in the cell group. In some embodiments a NULL pointer may be used in the handover trigger or the pre-configured cells in order to indicate no change to the previous configuration. For example, if the network knows that the cell change is intra-DU then it might indicate “NULL” cell group and a new candidate cell ID.

In addition to the configuration parts described above, measurement configurations and neighbour cell relationships may be determined in a similar manner. For example, by indicating that cells 1, 2, 3 are neighbours the WTRU knows that e.g., when on cell 1, the neighbours are cells 2 and 3 and the measurement configuration (e.g., SMTC) to use are the ones corresponding to cells 2 and 3.

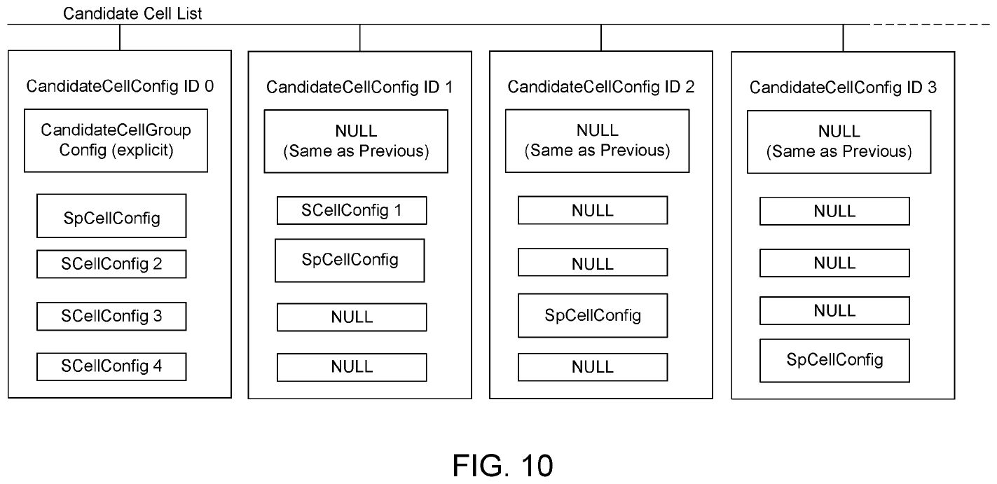

It is also possible, according to embodiments, to configure IDs implicitly. For example, one cell group configuration may be provided per candidate SpCell, along with a full configuration of SpCell and SCells, for example as per FIG. 10, which is an example alternative embodiment of coding of modular parts and relations.

In the example in this figure, four candidate cells are configured, each with the corresponding cell group configuration and SCell configuration. Since each candidate cell belongs to the same DU, the cell group configuration is the same and therefore may be provided only once, with the first candidate cell. The subsequent candidate cells include a NULL pointer indicating that the cell group configuration is the same as the previous one in the list (i.e., the one with candidate cell config ID 0). This way, when a handover trigger is received to change between any 2 of these cells, the same cell group configuration is referenced (for example, implicitly having ID 0). If a 5th cell (e.g. ID 4) is configured in this list with an explicit cell group configuration, then the further subsequent cells may be configured with a NULL pointer indicating the cell group configuration is the same as the configuration with ID 4. In this way, there are cells associated with the cell group configuration with index 0 and cells associated with the cell group configuration with index 5. A change of cell group configuration index may imply a change of DU and hence MAC reset.

According to embodiments, the SCells may be configured with an explicit serving cell ID. The PCell always has a serving cell ID of 0, so in the case of SCG, one potential encoding may be according to FIG. 10—the first candidate cell configuration may be provided with explicit configuration with SCells with serving cell identity 2, 3, 4. The second candidate cell configuration provides an explicit configuration for the SCell with serving cell identity 1, while the SCells with serving cell identity 3, 4 are referenced from the first candidate cell configuration. In the 3rd candidate cell configuration, SCells with serving cell identities 1, 3, 4 are referenced from the first 2 candidate cell configurations, and the 4th serving cell configuration references SCells with serving cell identities 1, 2, 3 from the first 2 candidate serving cell configurations. For SCG the SpCell may have any serving cell identity. In this case, the candidate cell configurations may provide an explicit serving cell identity for each SCell as well as the SpCell, however the configuration itself may be referenced in the same way—i.e., an explicit identity and a NULL pointer (if referencing another serving cell configuration) or an explicit configuration (if different to the previously configured serving cells) is provided for each serving cell in the configuration. The serving cells may, therefore, either be provided with an explicit serving cell identity, or an implicit serving cell identity based on either the position in the list or based on the serving cell type (PCell or other).

Regardless of whether an explicit (e.g., signalled) or an implicit (e.g., depending on a position within a list) ID is used to identify cell groups, cells, or individual configuration parts, the WTRU may be able to distinguish based on comparing a source (current) and a target (new) configuration which parts are different and therefore which parts to update and what associated procedures must be executed to perform the handover or cell reconfiguration.

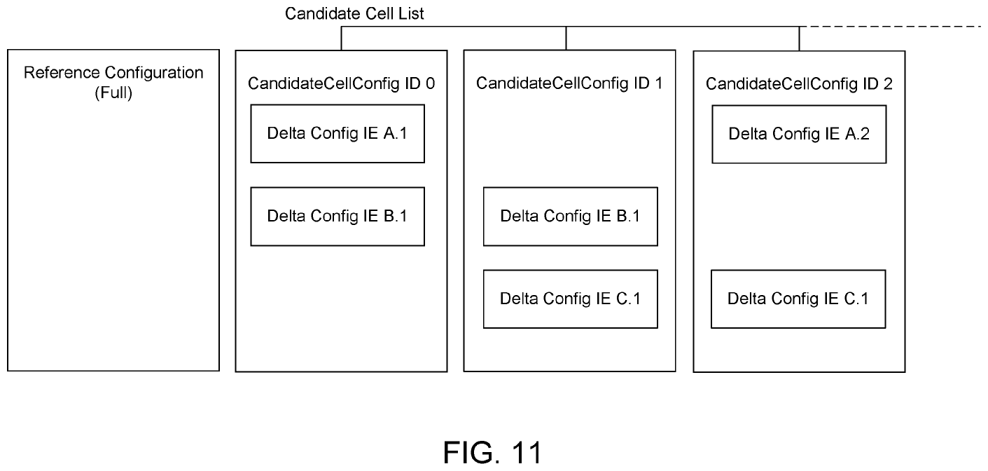

In an alternative example embodiment, the network provides a reference (full) configuration, which is either the current cell configuration, or is a reference (not yet applied) configuration. Each of the candidate cells may be provided as a delta configuration (from the reference full configuration). This is illustrated in FIG. 11, which represents an example alternative embodiment of coding of modular parts and relations.

In the example embodiment in this figure, the reference configuration may be provided. Each candidate cell configuration may be provided as a delta compared to the reference configuration. Candidate Cell ID 0 may contain delta configuration IE A.1 (this is IE type A, content version 1, for the sake of illustration) and delta configuration B.1. Candidate cell 1 has delta configuration IEs B.1 (the same IE, B, and content as this IE in cell 0) and C.1 (a different IE, C, not modified in cell 0). Candidate cell 2 has delta configuration IE A.2 (the same IE as in cell 0, but different content) and C.1 (the same IE and content as in cell 1).

Assuming the WTRU has applied the reference configuration on a current cell, when a handover is triggered to candidate cell 0 the WTRU may apply the delta configuration consisting of IEs A.1 and B.1 and takes the associated actions.

If a subsequent handover is made between cell 0 and cell 1, then the WTRU may compare the delta configurations of cells 0 and 1. Since IE A.1 is not modified in cell 1 compared to the reference configuration, the WTRU may revert the configuration of IE A to that provided in the reference configuration and may take associated actions (e.g., release measurement, reset MAC, and so on as listed earlier in the disclosure). Delta configuration B is the same in both cell 0 and cell 1, so no action is taken. Delta configuration C is performed on top of the reference configuration as it was not modified when reconfiguration to cell 0 was performed.

If a subsequent handover is made between cell 0 and cell 2, then the WTRU may compare the delta configurations of cells 0 and 2. The IE A is modified in both of these configurations, but is using different content. In one example embodiment the WTRU first reverts IE A to the original configuration, then applies configuration A.2. In an alternative example the IE applies the difference between A.1 and A.2 only. Configuration B is reverted to the reference configuration and configuration C.1 is applied as a delta compared to the reference configuration.

With this example embodiment, each candidate cell may be provided as a delta configuration compared to the reference configuration, which allows a closer resemblance to the legacy RRC reconfiguration message content, but it avoids having to apply the reference (full) configuration every time a handover is made-the WTRU may just compare the delta parts between the source and target cells, may revert any part of the configuration which is not different from the reference configuration, and may apply any (delta) changes which are different between the source and the target.

### Handover Using Modular RRC Configuration: Reconfiguration of the Reference and/or Candidate Configurations

Once the WTRU has been configured with a reference configuration, and a set of one or more candidate configurations (e.g., based on delta configuration or modular configurations as described above) the WTRU may be triggered via L1/2 signalling (e.g., MAC CE) to perform a reconfiguration, applying the target configuration as described above.

In a conventional network, when the WTRU receives an RRC Reconfiguration message it is applied directly, and in the case of a delta configuration, applies this delta configuration to the currently used configuration (i.e., the configuration in use when the RRC Reconfiguration is received, and before applying it). According to an embodiment, the network may perform an explicit RRC Reconfiguration by transmitting to the WTRU an RRC Reconfiguration message, and when the WTRU has been pre-configured with a reference configuration, the WTRU may receive an indication in the RRC Reconfiguration to specify whether the RRC Reconfiguration (e.g., containing a delta configuration) applies to the reference configuration, to the current cell configuration, or to both.

According to an embodiment, the WTRU has been pre-configured while on cell 1 with a reference configuration (e.g., the same as cell 1 configuration) and a delta configuration for cells 2 and 3 based on the reference configuration. After performing a L1/2 triggered mobility procedure, from cell 1 to cell 2, the WTRU applies the delta configuration corresponding to cell 2.

According to an embodiment when an RRC Reconfiguration is received by the WTRU when on cell 2, this RRC Reconfiguration may indicate that the WTRU does not update the currently used configuration but updates the reference configuration only. When the WTRU performs a subsequent L1/2 triggered mobility, for example from cell 2 to cell 3, the WTRU may need to apply the cell 3 delta configuration using the updated reference configuration. The updated reference configuration may be provided in a similar manner as any of the previous embodiments and examples. For example, using the example provided in FIG. 11, the updated reference configuration itself includes a delta configuration, which may have an ID. In any subsequent L1/2 triggered cell change, the WTRU may compare the previously configured target cell configuration with the updated reference configuration and apply the necessary changes and procedures to the parts which are different.

In another embodiment, when an RRC Reconfiguration is received by the WTRU when on cell 2, this RRC Reconfiguration may indicate that the WTRU updates both the currently used configuration and the reference configuration. A further indication may be received to indicate whether the stored delta configuration for this cell should also be updated or not. In the case that both the reference configuration and the current configuration are indicated as being updated, if the delta configuration is also to be updated then the parts of the new delta configuration corresponding to the reconfigured parameters will be the same as the reference configuration. For example, if the reference configuration is updated with a new RLC configuration, then the stored delta configuration for this cell will be “NULL” (e.g., the same as the reference). In the case that the delta configuration is not indicated to be updated, then the WTRU modifies the currently used configuration and the stored reference configuration, and (but) does not make any changes to the delta configuration stored for this cell. If the delta configuration for the current cell is not to be updated, the WTRU may calculate the new differences compared to the updated reference configuration. The delta would therefore be the original parts of the original reference configuration which have been updated (i.e., before the update), compared to the updated refence configuration (i.e., after the update)-so the WTRU may store, as part of the current cell delta configuration, the original parameters from the reference configuration, calculated as a delta from the updated reference configuration.

In another embodiment, when an RRC Reconfiguration is received by the WTRU when on cell 2, this RRC Reconfiguration may indicate that the WTRU updates both the currently used configuration but not the reference configuration. A further indication may be received to indicate whether the stored delta configuration for this cell should also be updated or not. In this case, the WTRU may simply update the current configuration, and when a subsequent L1/2 triggered cell changes occurs, the WTRU may revert to the (e.g., original) reference configuration before applying the new cell's delta configuration as before. The WTRU may or may not (e.g., based on an indication) update the stored reference configuration for the cell on which the RRC reconfiguration was received. Since the reference configuration was not updated in this example, the WTRU stores the updated delta configuration for this cell as a delta compared to the original reference configuration.

### Explicit Configuration per Source Cell with a Configuration of Whether to Reset a Protocol Layer at Switch to a Target

According to an embodiment, a WTRU may be alternatively or additionally configured with an explicit indication of whether or not to perform the reset/re-establishment of a protocol layer following L1/L2 mobility. A WTRU may further be configured with such indication per pair of source and target cell, specifically, a WTRU may receive an indication of whether L1/L2 mobility from a specific source cell to a specific target cell should/should not trigger a protocol layer reset (e.g., MAC reset or partial reset, RLC reset/re-establishment, PDCP re-establishment). Specifically, such indication may be per pair of cells (source and target). Upon L1/L2 mobility from a source cell to a target cell, a WTRU may determine whether to perform any of MAC reset, RLC reset, PDCP re-establishment, etc., based on the indication received that is associated to the source/target cell in question. The WTRU may receive such indication per pair of source/target cell in RRC signaling, for example, for all source/target cell pairs in an area, or for all candidate L1/L2 mobility targets at the time of RRC reconfiguration, or for all candidate L1/2 mobility targets sharing a same MAC or RLC or PDCP configuration ID.

In a similar fashion, according to an embodiment, a WTRU may be configured with an indication per source and target cell pair of whether to perform RACH-less mobility or RACH-based mobility.

### Indication or Determination of Whether to Apply a Delta Configuration on Top of a Reference Configuration or the Source Cell Configuration

According to embodiments, the WTRU may be configured with one or more L1/2 triggered mobility (LTM) candidate configurations, which are delta configurations (e.g., partial configurations containing only the difference between a current or reference configuration). In some embodiments, the configuration (e.g., the LTM candidate configuration) may contain an indication whether the delta configuration is to be applied to the source cell configuration (e.g., similar to a conventional RRC Reconfiguration containing a delta configuration) or on top of a reference configuration (e.g., WTRU first applies a reference configuration, and then applies the delta configuration, or the WTRU constructs a full configuration to be applied based on the reference configuration+the delta configuration). In some embodiments, a MAC CE containing a candidate configuration index (e.g., a MAC CE used for triggering an LTM cell switch) may provide an indication of whether to apply the candidate delta configuration on top of the source cell configuration or a reference configuration.

In some embodiments, candidate configurations may be provided for cells belonging to one or more DUs. In case the WTRU is triggered (e.g., using a MAC CE) to perform cell switch to a target cell belonging to the same DU as the source cell, an indication may be provided to apply the delta configuration on top of the source cell (e.g., the current) configuration. In case the WTRU is triggered to perform a cell switch to a target cell belonging to a different DU, an indication may be provided to apply the delta configuration on top of a reference configuration. With this embodiment, it is possible to provide a number of candidate configurations using a delta compared to the source cell corresponding to cells on the same DU as the source cell, and a number of candidate configurations with a delta compared to a reference configuration, the reference configuration corresponding to a configuration for a different DU than the source cell. In this way, the configuration overhead may be minimised by providing a reference configuration to be applied only if the LTM trigger indicates a change of DU, otherwise the delta configuration is applied on top of the source cell configuration.

In some embodiments the WTRU determines whether or not to apply the candidate delta configuration on top of the source cell configuration or a reference configuration. For example, for the first LTM execution corresponding to a cell switch with a candidate configuration on top of a certain reference configuration, the WTRU may first apply the reference configuration and then apply the delta configuration. For subsequent cell switches, the WTRU may determine that the reference configuration does not need to be applied, and the delta configuration may be applied directly to the source cell configuration because the source cell configuration already includes the reference configuration. In some embodiments, the WTRU may compare an identifier associated with a first cell, and an identifier associated with a second cell, to determine whether to apply the delta configuration associated with the second cell on top of the first cell configuration or on top of a reference configuration.

By applying the delta configuration on top of a source cell configuration, the amount of reconfiguration (e.g., amount of WTRU processing) may be reduced compared to always applying a reference configuration before the delta configuration. A reference configuration may therefore only need to be applied in certain scenarios, for example the first LTM cell switch, or the first LTM cell switch to a new DU, while subsequent LTM cell switches may apply the delta configuration using a similar procedure as the conventional handover.

In some embodiments, the WTRU may receive an indication with an identifier to one of one or more reference configurations. The absence of such indication may be interpreted by the WTRU as an indication to apply a candidate delta configuration on top of the source cell configuration. In some embodiments, the absence of a configuration of a reference configuration (e.g., if the WTRU is configured with one or more candidates using a delta configuration, but no reference configuration is provided) may be interpreted by the WTRU as an indication to apply a candidate delta configuration on top of the source cell configuration, while the presence of a reference configuration is interpreted as an indication to apply a reference configuration. In some embodiments, the WTRU stores a reference configuration until a first LTM cell switch is triggered and deletes the reference configuration after applying the LTM cell switch (so now the WTRU has no reference configuration, and applies any subsequent cell switches using a delta configuration on top of the source cell configuration, which has already applied the deleted reference configuration).

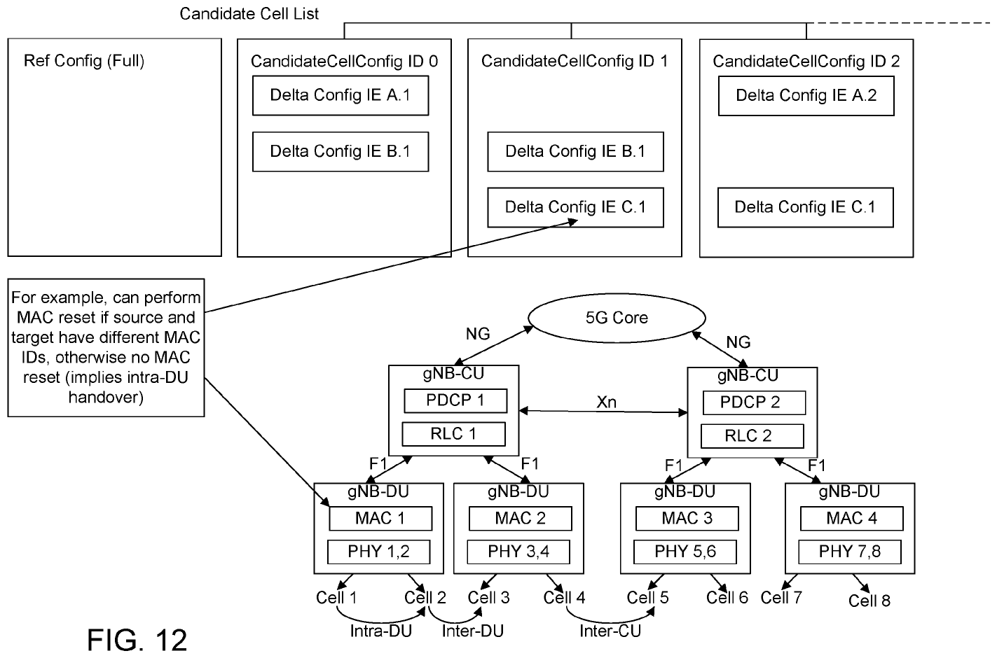

FIG. 12 is related to steps 704 and 705a-b of FIG. 7 while referring to the further alternative embodiment of FIG. 11. The 5G Base Transceiver Station (BTS) named gNB can be divided into two physical entities named CU (Centralized Unit) and DU (Distributed Unit). CU provides support for the higher layers of the protocol stack while DU provides support for the lower layers of the protocol stack. The figure shows example Intra-DU handover e.g., from Cell1 to Cell2, Inter-DU handover e.g. from Cell2 to Cell3, and Inter-CU handover e.g. from Cell4 to Cell5. For example, a MAC reset may be performed in step 705b of FIG. 7 in case of an Inter-DU handover from Cell2 to Cell3 (as source and target have different MAC IDs), while a MAC reset is not performed in step 705a in case of an Intra-DU handover from Cell1 to Cell2 (as source and target have same MAC IDs).

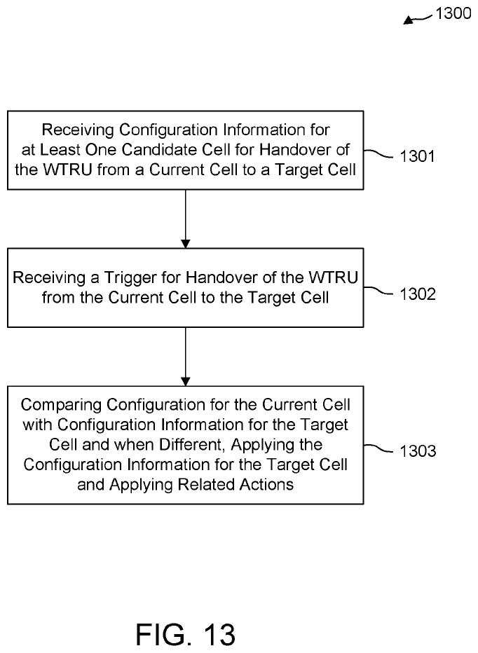

FIG. 13 is a flow chart of a method 1300, implemented by a WTRU, for cell handover according to an embodiment.

In 1301, the WTRU receiving configuration information for at least one candidate cell for handover of the WTRU from a current cell to a target cell among the at least one candidate cell for handover, the configuration information comprising, for each of the at least one candidate cell, configuration parts corresponding to configurations that are different from a reference configuration;

In 1302, the WTRU receiving a handover trigger for handover of the WTRU from the current cell to the target cell;

In 1303, the WTRU comparing configuration information for the current cell with the configuration information for the target cell, and when the configuration information for the target cell is different from the configuration information for the current cell, applying the configuration information for the target cell and applying actions related to the applied configuration information for the target cell.

According to an embodiment of the method, the configuration information is radio resource control (RRC) information.

According to an embodiment of the method, the configuration parts are any of centralized unit (CU), distributed unit (DU), and cell specific parts.

According to an embodiment of the method, the configuration parts are any of secondary cell group (SCG) and master cell group (MCG) specific parts.

According to an embodiment of the method, each configuration part of the configuration parts has an associated identifier, the associated identifier corresponding to a radio bearer configuration identifier for a CU specific part, to a candidate cell group configuration identifier for a DU specific part, to a candidate cell configuration identifier for a cell specific part.

According to an embodiment of the method, when the associated identifier corresponds to a radio bearer configuration identifier, the actions comprise any of packet data convergence protocol (PDCP) reestablishment and radio link control (RLC) reestablishment.

According to an embodiment of the method, when the associated identifier corresponds to a candidate cell group configuration identifier, the actions comprise medium access control (MAC) reset.

According to embodiments, there is provided a WTRU comprising at least one processor, wherein the at least one processor is configured to perform any of steps 1301-1303.

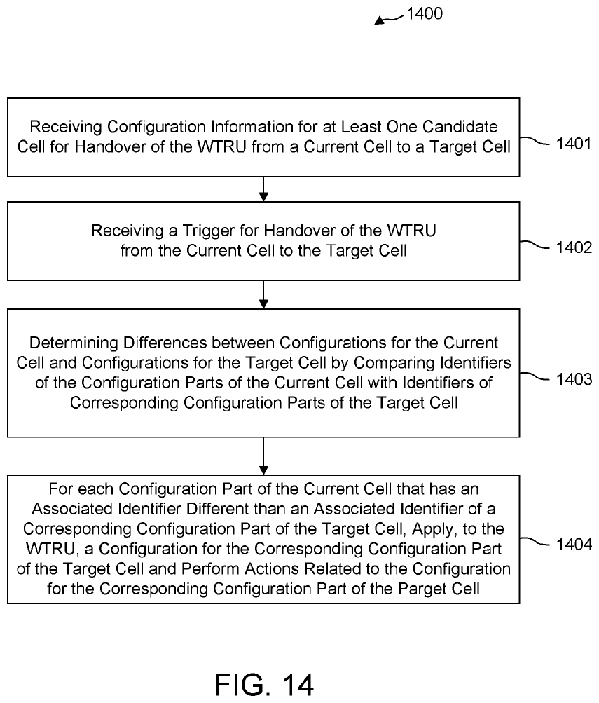

FIG. 14 is a flow chart of a method 1400, implemented by a WTRU, for cell handover according to a further embodiment.

In 1401, the WTRU receiving configuration information for at least one candidate cell for handover of the WTRU from a current cell to a target cell among the at least one candidate cell for handover, the configuration information comprising, for each of the at least one candidate cell, configuration parts and, per configuration part, an associated identifier;

In 1402, the WTRU receiving a handover trigger for handover of the WTRU from the current cell to the target cell;

In 1403, the WTRU determining differences between configuration for the current cell and configuration for the target cell by comparing identifiers of the configuration parts of the current cell with identifiers of corresponding configuration parts of the target cell; and

In 1404, the WTRU, for each configuration part of the current cell that has an associated identifier different than an associated identifier of a corresponding configuration part of the target cell, applying, to the WTRU, a configuration for the corresponding configuration part of the target cell and performing actions related to the configuration for the corresponding configuration part of the target cell.

According to an embodiment of the method, the configuration information is radio resource control (RRC) information.

According to an embodiment of the method, the configuration parts are any of centralized unit (CU), distributed unit (DU), and cell specific parts.

According to an embodiment of the method, the configuration parts are any of secondary cell group (SCG) and master cell group (MCG) specific parts.

According to an embodiment of the method, each configuration part of the configuration parts has an associated identifier, the associated identifier corresponding to a radio bearer configuration identifier for a CU specific part, to a candidate cell group configuration identifier for a DU specific part, to a candidate cell configuration identifier for a cell specific part.

According to an embodiment of the method, when the associated identifier corresponds to a radio bearer configuration identifier, the actions comprise any of packet data convergence protocol (PDCP) reestablishment and radio link control (RLC) reestablishment.

According to an embodiment of the method, when the associated identifier corresponds to a candidate cell group configuration identifier, the actions comprise medium access control (MAC) reset.

According to embodiments, there is provided a WTRU comprising at least one processor, wherein the at least one processor is configured to perform any of steps 1401-1404.

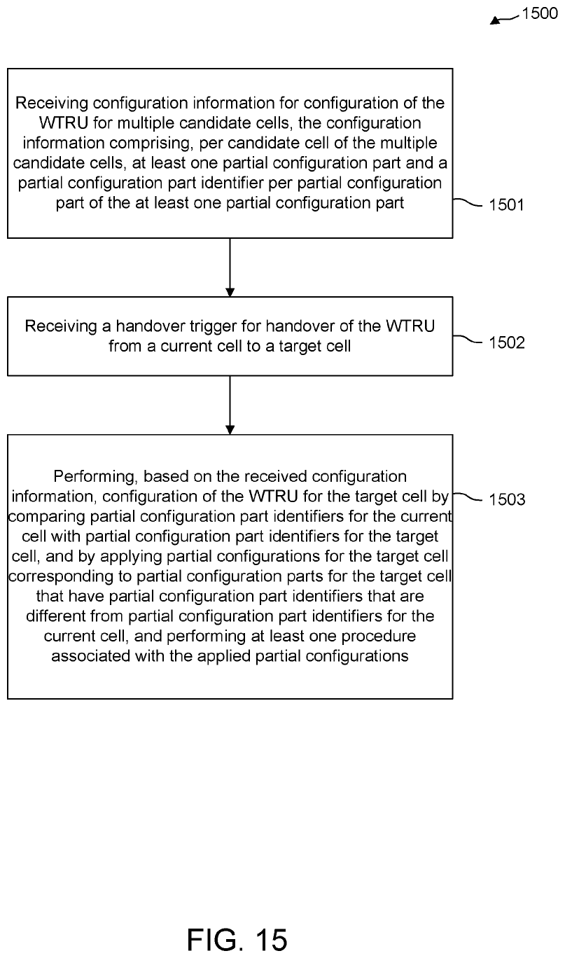

FIG. 15 is a flow chart of a method 1500, implemented by a WTRU, for cell handover according to an embodiment.

In 1501, the method comprises receiving configuration information for configuration of the WTRU for multiple candidate cells, the configuration information comprising, per candidate cell of the multiple candidate cells, at least one partial configuration part and a partial configuration part identifier per partial configuration part of the at least one partial configuration part.

In 1502, the method comprises receiving a handover trigger for handover of the WTRU from a current cell to a target cell.

In 1503, the method comprises performing, based on the received configuration information, configuration of the WTRU for the target cell by comparing partial configuration part identifiers for the current cell with partial configuration part identifiers for the target cell, and by applying partial configurations for the target cell corresponding to partial configuration parts for the target cell that have partial configuration part identifiers that are different from partial configuration part identifiers for the current cell, and performing at least one procedure associated with the applied partial configurations.

According to an embodiment, the method comprises performing a medium access control, MAC, reset when partial configuration part identifiers associated with MAC configurations for the WTRU for the current cell and the target cell are not identical.

According to an embodiment, the method comprises performing at least one of: a radio link control, RLC, reset when partial configuration part identifiers associated with RLC configurations for the WTRU for the current cell and for the target cell are not identical; a packet data convergence protocol, PDCP, reset when partial configuration part identifiers associated with PDCP configurations for the WTRU for the current cell and for the target cell are not identical.

According to an embodiment of the method, the at least one partial configuration part is any of: a centralized unit, CU; a distributed unit, DU; a cell specific partial configuration part.

According to an embodiment of the method, the at least one partial configuration part is any of a secondary cell group, SCG, and a master cell group, MCG, partial configuration specific part.

According to an embodiment of the method, the partial configuration part identifier corresponds to a radio bearer configuration identifier for a CU specific partial configuration part, to a candidate cell group configuration identifier for a DU specific part, to a candidate cell configuration identifier for a cell specific partial configuration part.

According to an embodiment of the method, when the partial configuration part identifier corresponds to a radio bearer configuration identifier, the procedures associated with the applied partial configurations comprise at least one of: a radio link control, RLC, reestablishment; a packet data convergence protocol, PDCP, reestablishment.

There is also disclosed a wireless transmit-receive unit, WTRU, device. The WTRU device comprises at least one processor. The at least one processor is configured:
to receive configuration information for configuration of the WTRU for multiple candidate cells, the configuration information comprising, per candidate cell of the multiple candidate cells, at least one partial configuration part and a partial configuration part identifier per partial configuration part of the at least one partial configuration part;
to receive a handover trigger for handover of the WTRU from a current cell to a target cell;
to perform, based on the received configuration information, configuration of the WTRU for the target cell by comparing partial configuration part identifiers for the current cell with partial configuration part identifiers for the target cell, and by applying partial configurations for the target cell corresponding to partial configuration parts for the target cell that have partial configuration part identifiers that are different from partial configuration part identifiers for the current cell, and to perform (/ by performing) at least one procedure associated with the applied partial configurations.

According to an embodiment, the at least one processor is configured to perform a medium access control, MAC, reset when partial configuration part identifiers associated with MAC configurations for the WTRU for the current cell and the target cell are not identical.

According to an embodiment, the at least one processor is configured to perform at least one of: a radio link control, RLC, reset when partial configuration part identifiers associated with RLC configurations for the WTRU for the current cell and for the target cell are not identical; a packet data convergence protocol, PDCP, reset when partial configuration part identifiers associated with PDCP configurations for the WTRU for the current cell and for the target cell are not identical.

According to an embodiment, the at least one partial configuration part is any of: a centralized unit, CU; a distributed unit, DU; a cell specific partial configuration part.

According to an embodiment, the at least one partial configuration part is any of a secondary cell group, SCG, and a master cell group, MCG, partial configuration specific part.

According to an embodiment, the partial configuration part identifier corresponds to a radio bearer configuration identifier for a CU specific partial configuration part, to a candidate cell group configuration identifier for a DU specific part, to a candidate cell configuration identifier for a cell specific partial configuration part.

According to an embodiment, when the partial configuration part identifier corresponds to a radio bearer configuration identifier, the procedures associated with the applied partial configurations comprise at least one of: a radio link control, RLC, reestablishment; a packet data convergence protocol, PDCP, reestablishment.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1-14. (canceled)

15. A method, implemented by a wireless transmit-receive unit (WTRU), the method comprising:
receiving configuration information for configuration of the WTRU for multiple candidate cells, the configuration information comprising, per candidate cell of the multiple candidate cells, at least one partial configuration part and a partial configuration part identifier per partial configuration part of the at least one partial configuration part;
receiving a handover trigger for handover of the WTRU from a current cell to a target cell; and
performing, based on the received configuration information, configuration of the WTRU for the target cell by comparing partial configuration part identifiers for the current cell with partial configuration part identifiers for the target cell, and by applying partial configurations for the target cell corresponding to partial configuration parts for the target cell that have partial configuration part identifiers that are different from partial configuration part identifiers for the current cell, and performing a radio link control (RLC) reset when partial configuration part identifiers associated with RLC configurations for the WTRU for the current cell and for the target cell are not identical.

16. The method according to claim 15, wherein the configuration information is a reference configuration, and the at least one partial configuration part is a candidate cell configuration.

17. The method according to claim 15, comprising performing a medium access control (MAC) reset when partial configuration part identifiers associated with MAC configurations for the WTRU for the current cell and the target cell are not identical.

18. The method according to claim 15, wherein the at least one partial configuration part is any of: a centralized unit (CU); a distributed unit (DU); a cell specific partial configuration part.

19. The method according to claim 15, wherein the at least one partial configuration part is any of a secondary cell group (SCG) and a master cell group (MCG) partial configuration specific part.

20. The method according to claim 18, wherein the partial configuration part identifier corresponds to a radio bearer configuration identifier for a CU specific partial configuration part, to a candidate cell group configuration identifier for a DU specific part, to a candidate cell configuration identifier for a cell specific partial configuration part.

21. The method according to claim 18, wherein, when the partial configuration part identifier corresponds to a radio bearer configuration identifier, the method comprises an RLC reestablishment.

22. A wireless transmit-receive unit (WTRU) device comprising at least one processor configured to:
receive configuration information for configuration of the WTRU device for multiple candidate cells, the configuration information comprising, per candidate cell of the multiple candidate cells, at least one partial configuration part and a partial configuration part identifier per partial configuration part of the at least one partial configuration part;
receive a handover trigger for handover of the WTRU device from a current cell to a target cell; and
perform, based on the received configuration information, configuration of the WTRU device for the target cell by comparing partial configuration part identifiers for the current cell with partial configuration part identifiers for the target cell, and by applying partial configurations for the target cell corresponding to partial configuration parts for the target cell that have partial configuration part identifiers that are different from partial configuration part identifiers for the current cell, and to perform a radio link control (RLC) reset when partial configuration part identifiers associated with RLC configurations for the WTRU for the current cell and for the target cell are not identical.

23. The WTRU device according to claim 22, wherein the configuration information is a reference configuration, and the at least one partial configuration part is a candidate cell configuration.

24. The WTRU device according to claim 22, wherein the WTRU device is configured for performing a medium access control (MAC) reset when partial configuration part identifiers associated with MAC configurations for the WTRU device for the current cell and the target cell are not identical.

25. The WTRU device according to claim 22, wherein the at least one partial configuration part is any of: a centralized unit (CU); a distributed unit (DU); a cell specific partial configuration part.

26. The WTRU device according to claim 22, wherein the at least one partial configuration part is any of a secondary cell group (SCG) and a master cell group (MCG) partial configuration specific part.

27. The WTRU device according to claim 25, wherein the partial configuration part identifier corresponds to a radio bearer configuration identifier for a CU specific partial configuration part, to a candidate cell group configuration identifier for a DU specific part, to a candidate cell configuration identifier for a cell specific partial configuration part.

28. The WTRU device according to claim 25, wherein, when the partial configuration part identifier corresponds to a radio bearer configuration identifier, the at least one processor is configured to perform an RLC reestablishment.
